(19) United States
(12) Patent Application Publication
(10) Pub. No.: US 2005/0136186 A1
(43) Pub. Date: Jun. 23, 2005

(54) Powdered thermosetting composition for coatings

(76) Inventors: Luc Moens, Sint-Genesius-Rode (BE); Nele Knoops, Herent (BE); Daniel Maetens, Brussels (BE)

Correspondence Address: WENDEROTH, LIND & PONACK, L.L.P., 2033 K STREET N. W., SUITE 800, WASHINGTON, DC, 20006-1021, US

(21) Appl. No.: 11/028,613

(22) Filed: Jan. 5, 2005

Related U.S. Application Data
(63) Continuation of application No. 10/204,466, filed on Nov. 18, 2002, now abandoned.

(30) Foreign Application Priority Data
Dec. 21, 2000 (EP) 00128098.1

(51) Int. Cl. B05D 3/02; B32B 27/00

(52) U.S. Cl. 427/375; 428/500

(57) ABSTRACT

The present invention relates to powdered thermosetting compositions including a binder which comprises a carboxyl group containing amorphous isophthalic acid containing polyester, a carboxyl group containing aliphatic semi-crystalline polyester, an optional and different carboxyl group containing semi-crystalline polyester, at least 5 parts by weight, based on the total weight of the binder, of a specific glycidyl group containing acrylic copolymer and a curing agent having functional groups reactive with the polyesters' carboxyl groups. The powdered thermosetting compositions are useful for the preparation of powdered paints and varnishes which give semi-matt coatings having an outstanding flow, a remarkable weatherability and excellent mechanical properties.

The present invention relates to powdered thermosetting compositions comprising as binder a co-reactable particulate mixture of a carboxyl group containing amorphous polyester, a carboxyl group containing aliphatic semi-crystalline polyester, a glycidyl group containing acrylic copolymer and a β-hydroxyalkylamide group containing curing agent whose functional groups are reactive with the polyesters' carboxyl groups. Optionally, the compositions may contain another carboxyl group containing semi-cristalline polyester. The invention also relates to the use of said compositions for the preparation of powdered paints and varnishes which give semi-matt coatings providing an outstanding flow, a remarkable weatherability and excellent mechanical properties. The invention further relates to the semi-matt coatings obtainable from said compositions.

Powdered thermosetting compositions are widely used as paints and varnishes for coating the most various articles. These powders have numerous advantages. On the one hand the problems associated with solvents are completely eliminated and on the other hand the powders are not wasted, since only the powder in direct contact with the article is retained on the article, any excess powder being, in principle, entirely recoverable and reusable. For these and other reasons, powdered coating compositions are preferred to coating compositions in the form of solutions in e.g. organic solvents.

Powdered coating compositions should give coatings which have a good adhesion to metal substrates like steel or aluminium, a nice flow without defects and orange peel, a good flexibility and weatherability as well as a good chemical resistance. Besides, powdered coating compositions should exhibit a sufficiently high glass transition temperature to avoid reagglomeration during handling, transportation and storage.

The majority of today's coating compositions provide coatings having a high gloss after fusion and curing. The gloss measured at an angle of 60° in accordance with ASTM D523 is in fact often equal to or indeed even greater than 90%.

For example, WO 97/20895 discloses powdered thermosetting compositions including a binder consisting of a mixture of semi-crystalline and amorphous polyesters containing carboxyl groups, and a cross-linking agent with functional groups capable of reacting with the carboxyl groups of the polyesters. The powdered thermosetting compositions are useful for preparing powdered varnishes and paints and provide coatings having a remarkable weather resistance, high gloss and excellent mechanical properties.

WO 91/14745 discloses a thermosetting powder coating composition comprising as binder a co-reactable particulate mixture of a carboxylic acid-functional semi-crystalline polyester component and a curing agent having groups reactable with carboxylic acid groups. The composition may, if desired, include an amorphous polyester, which is said to afford coatings with improved weathering performance and improved resistance to gloss reduction of the coating during outdoor exposure. So-called “hybrid” powder coating compositions comprise an epoxy resin as a co-reactable curing agent. Polyglycidyl-functional acrylic polymers are mentioned among numerous other epoxy resins. The coatings obtained from these thermosetting powder compositions exhibit a high gloss.

While powdered compositions which provide high gloss coatings with good appearance and mechanical properties as well as good weather resistance are known, there is an increasing demand for powdered paints and varnishes which provide matt or semi-matt coatings of good quality, for example for coating certain accessories in the automotive industry, such as wheel rims, bumpers and the like, or for coating metal panels and beams used in construction.

Thus, various methods for manufacturing powdered paints and varnishes that provide matt or semi-matt coatings, have been proposed.

According to one of these methods one or more matting agents, such as described in U.S. Pat. No. 4,242,253, are introduced into the powdered composition, in addition to the binder and conventional pigments.

U.S. Pat. No. 3,842,035 relates to a heat curable powder coating composition which, upon curing, gives a matt finish and which comprises a mixture of a slow curing and a fast curing thermosetting powder composition. The two compositions are extruded separately before dry-blending.

WO 92/01756 describes powder coating compositions comprised of one or more semi-crystalline hydroxyl polyesters, one or more amorphous polyesters and one or more hydroxyl acrylic polymers and a blocked polyisocyanate cross-linking agent. Coatings of the compositions on shaped metal articles exhibit an ASTM D-523-85 60° gloss value of not greater than 35.

In EP-A-0 551 064 powdered thermosetting compositions comprising as binder a mixture of a linear carboxyl group containing polyester and a glycidyl group containing acrylic copolymer are described. The acrylic polymer must have a number averaged molecular weight (Mn) of 4000 to 10000 in order to obtain coatings with useful physical properties. The compositions are useful for the preparation of powdered paints and varnishes which produce matt finishes having a gloss value measured at an angle of 60° in accordance with ASTM D523 equal to or less than 15.

Despite the existing variability of methods for producing matt or semi-matt finishes, experience has shown that these methods are all subject to one or more disadvantages attributed to problems of processing, as well as to overall coating performances. Problems are particularly relating to reproducibility and reliability of the gloss value.

There is thus still a need for powdered thermosetting compositions, capable of producing semi-matt coatings which do not exhibit the defects and drawbacks of the prior art.

In addition there is a sustained effort to improve flexibility and weatherability of the semi-matt finishes in order to get them appropriate for applications such as coil coating, for example intended for outdoor construction purposes, especially for use in regions having a tropical climate.

However, when semi-matt finishes are considered, no method is known today for preparing thermosetting powdered compositions from a single extrusion, which, upon curing, provide criteria such as outstanding flow, remarkable weatherability and excellent flexibility and for which low gloss values are perceived in a reproducible and reliable manner.

According to the present invention, it now has been surprisingly found that by using as binder a co-reactable particulate mixture of a carboxyl group containing amorphous isophthalic acid containing polyester, a carboxyl group containing aliphatic semi-crystalline polyester, optionally another carboxyl group containing semi-crystalline polyester, at least 5 parts by weight of a specific glycidyl group containing acrylic copolymer and a β-hydroxyalkylamide group containing curing agent having functional groups reactive with the polyesters' carboxyl groups, it is possible to obtain powdered thermosetting compositions which produce coatings exhibiting the desired characteristics.

Thus, according to the present invention there is provided a powdered thermosetting composition including a binder which comprises
(a) a carboxyl group containing amorphous isophthalic acid containing polyester,
(b) a carboxyl group containing aliphatic semi-crystalline polyester,
(c) optionally, a carboxyl group containing semi-crystalline polyester other than (b);
(d) at least 5 parts by weight, based on the total weight of the binder, of a glycidyl group containing acrylic copolymer, said copolymer comprising at least 10 mole % of a glycidyl group containing monomer and having a number averaged molecular weight (Mn) of 10000 or less, and
(e) a β-hydroxyalkylamide group containing curing agent whose functional groups are reactive with the polyesters' carboxyl groups.

The present composition is useful for preparing semi-matt coatings, i.e. coatings having a gloss value measured at an angle of 60° in accordance with ASTM D523 between, 20 and 80.

In the sense of the present application the term “isophthalic acid containing polyester” refers to a polyester which is composed of at least 10 mole % of isophthalic acid, preferably at least 50 mole % based on the total acid constituents of the polyester.

The amorphous polyester and the semi-crystalline polyesters independently may be linear or branched.

The carboxyl group containing amorphous polyester (a) of the present composition is preferably composed of, referring to the acid constituents, from 10 to 100 mole % of isophthalic acid, preferably 50 to 100 moles %, and from 90 to 0 mole % of another diacid, such as an aliphatic, cycloaliphatic or aromatic diacid, and, referring to the alcohol constituents, from 35 to 100 mole % of neopentyl glycol and/or 2-butyl-2-ethyl-1,3-propanediol and from 65 to 0 mole % of another diol, such as an aliphatic or cycloaliphatic diol. Branching of the amorphous polyester can be obtained by incorporation of a polyacid or polyol.

The acid constituent of the amorphous polyester, which is not the isophthalic acid, may preferably be selected from one or more aliphatic, cycloaliphatic or aromatic diacids, such as fumaric acid, maleic acid, phthalic acid, terephthalic acid, 1,4-cyclohexanedicarboxylic acid, 1,3-cyclohexanedicarboxylic acid, 1,2-cyclohexanedicarboxylic acid, succinic acid, adipic acid, glutaric acid, pimelic acid, suberic acid, azelaic acid, sebacic acid, 1,12-dodecanedioic acid, etc., or the corresponding anhydrides.

Incorporation of e.g. up to 15 mole % relative to the diacid, of polyacids having at least three carboxylic acid groups such as trimellitic acid or pyromellitic acid or their corresponding anhydrides or mixtures thereof, induces branching of the polyester.

The glycol constituent of the amorphous polyester, which is not the neopentyl glycol and/or 2-butyl-2-ethyl-1,3-propanediol, may preferably be selected from one or more aliphatic or cycloaliphatic glycols, such as ethylene glycol, propylene glycol, 1,4-butanediol, 1,6-hexanediol, 1,4-cyclohexanediol, 1,4-cyclohexanedimethanol, 2-methyl- 1,3-propanediol, hydrogenated Bisphenol A, hydroxypivalate of neopentyl glycol, etc.

Incorporation of e.g. up to 15 mole % relative to the neopentyl glycol and/or 2-butyl-2-ethyl-1,3-propanediol, of trifunctional or tetrafunctional polyols such as trimethylolpropane, di-trimethylolpropane, pentaerythrytol or mixtures thereof, induces branching of the polyester.

The carboxyl group containing amorphous polyesters (a) of the present composition preferably have an acid number (AN) from 15 to 70 mg KOH/g and in particular from 20 to 50 mg KOH/g.

The carboxyl group containing amorphous polyesters are advantageously further characterised by:
a number averaged molecular weight (Mn) ranging from 1600 to 11000 and preferably from 2200 to 5600, measured by gel permeation chromatography (GPC);
a glass transition temperature (Tg) from 40 to 80° C., measured by Differential Scanning Calorimetry according to ASTM D3418 with a heating gradient of 20° C. per minute; and
an ICI (cone/plate) viscosity accordingly to ASTM D4287-88, measured at 200° C. ranging from 5 to 15000 mPa.s.

The carboxyl group containing amorphous polyester may fulfill one or more of the above conditions for its acid number, its number averaged molecular weight, its glass transition temperature and its ICI viscosity. Preferably, the amorphous polyester, however, fulfills all of these requirements.

The carboxyl functional aliphatic semi-crystalline polyester (b) is composed of, referring to the acid constituents, 40 to 100 mole % of a linear chain dicarboxylic acid containing 10 to 16 carbon atoms and 0 to 60 mole % of at least one linear chain dicarboxylic acid containing 4 to 9 carbon atoms. The alcohol constituents of the carboxyl functional aliphatic semi-crystalline polyester (b) is selected from at least one aliphatic non-branched or cycloaliphatic diol containing 2 to 16 carbon atoms.

The linear chain dicarboxylic acid containing 10 to 16 carbon atoms of the carboxylic functional aliphatic semi-crystalline polyester (b) is selected among 1,10-decanedioic acid, 1,11-undecanedioic acid 1,12-dodecanedioic acid, 1,13-triadecanedioic acid, I,14-tetradecanedioic acid, 1,15-pentadecanedioic acid, 1,16-hexadecanedioic acid, used in a mixture or alone.

The linear chain dicarboxylic acid containing 4 to 9 carbon atoms of the carboxyl functional aliphatic semi-crystalline polyester (b) is selected from succinic acid, adipic acid, glutaric acid, pimelic acid, suberic acid, azealic acid. The aliphatic non-branched or cycloaliphatic diol containing 2 to 16 carbon atoms of the carboxyl functional aliphatic semi-crystalline polyester (b) is selected from ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol, 1,14-tetradecanediol, 1,16-hexadecanediol or 1,4-cyclohexanediol, 1,4-cyclohexanedimethanol, hydrogenated Bisphenol A, 2,2,4,4-tetramethyl-1-3-cyclobutanediol or 4,8-bis(hydroxy-methyl)tricyclo[5.2.1.0^{2,6}]decane, used as a mixture or alone.

The second carboxyl functional semi-crystalline polyester (c), optionally used in the formulation of the present invention, is composed of from 75 to 100 mole % of terephtalic acid and/or of 1,4-cyclohexanedicarboxylic acid and/or a linear chain dicarboxylic acid containing 4 to 9 carbon atoms and from 25 to 0 mole % of another aliphatic, cycloaliphatic or aromatic diacid.

The alcohol constituent of the second carboxyl functional semi-crystalline polyester (c), optionally used in the formulation of the present invention, is composed of from 75 to 100 mole % of a cycloaliphatic or linear chain diol containing 2 to 16 carbon atom and from 25 to 0 mole % of another aliphatic glycol.

The linear chain dicarboxylic acid containing 4 to 9 carbon atoms of the second optional carboxyl functional semi-crystalline polyester (c) is selected among succinic acid, adipic acid, glutaric acid, pimelic acid, suberic acid and azealic acid, used in a mixture or alone, and the 25 to 0 mole of the other aliphatic, cycloaliphatic or aromatic diacid is selected from fumaric acid, maleic anhydride, phthalic anhydride, isophthalic acid, 1,3-cyclohexanedicarboxylic acid, 1,2-cyclohexanedicarboxylic acid, used in a mixture or alone.

The cycloaliphatic or linear chain diol containing 2 to 16 carbon atoms of the second optional carboxyl functional semi-crystalline polyester (c) is selected from ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol, 1,14-tetradecanediol, 1,16-hexadecanediol or 1,4-cyclohexanediol, 1,4-cyclohexanedimethanol, hydrogenated Bisphenol A, 2,2,4,4-tetramethyl-1,3-cyclobutanediol or 4,8-bis(hydroxymethyl)tricyclo[5.2.1.0^{2.6}]decane, used as mixture or alone, and the 25 to 0 mole % of the other aliphatic glycol is selected from propylene glycol, neopentyl glycol, 2-methyl- 1,3-propanediol, 2-butyl-2-ethyl- 1,3-propanediol, hydroxypivalate of neopentyl glycol, used alone or in admixture.

Both carboxyl functional semi-crystalline polyesters (b) and (c) of the present invention can be linear or branched.

When branching is needed, incorporation of up to 15 mole %, based on the total of diacids, of polyacids having at least three carboxyl acid groups, such as pyromellitic acid or trimellitic acid or their corresponding anhydrides or of up to 15 mole % based on the amount of diols, of trifunctional or tetrafuntional polyols such as trimethylolpropane, di-trimethylolpropane, pentaerythrytol or mixtures of them can be performed.

Both carboxyl functional semi-crystalline polyesters (b) and (c) of the present invention have an acid number (AN) from 10 to 50 mg KOH/g and preferably from 20 to 40 mg KOH/g.

They are further characterized by:
a number averaged molecular weight (Mn) rangin from 2200 to 17000 and preferably from 2800 to 8500;
a fusion zone from 30 to 150° C., measured by Differential Scanning Calorimetry (DSC) according to ASTM D3418 with a heating gradient of 20° C. per minute;
a glass transition temperature (Tg) from −50 to +50° C., measured by Differential Scanning Calorimetry (DSC) according to ASTM D3418 with a heating gradient of 20° C. per minute;
a degree of crystallinity, measured by Differential Scanning Calorimetry (DSC) according to ASTM D3415 of at least 5 J/g and preferably at least 10 J/g;
an ICI (cone/plate) viscosity according to ASTM D4287-88, measured at 175° C. ranging from 5 to 20000 mPa.s.

Both carboxyl group containing semi-crystalline polyesters (b) and (c) may fulfill one or more of the above conditions for the acid number, the number averaged molecular weight, the fusion zone, the glass transition temperature, the degree of crystallinity and the ICI viscosity. Preferably, the semi-crystalline polyesters, however, fulfill all of the above requirements. The glycidyl group containing acrylic copolymer (d) of the present composition is preferably composed of 10 to 90 mole % of a glycidyl group containing monomer and from 90 to 10 mole % of other monomers copolymerisable with the glycidyl group containing monomer.

The glycidyl group containing monomer used in the acrylic copolymer of the present composition may be selected from, for example, glycidyl acrylate, glycidyl methacrylate, methyl glycidyl methacrylate, methyl glycidyl acrylate, 3,4-epoxycyclohexylmethyl (meth)acrylate and acrylic glycidyl ether. These monomers can be used singly or in combination of two or more.

The other monomers of the acrylic copolymer copolymerisable with the glycidyl group containing monomer may be selected from:
40 to 100 mole percentage of acrylic or methacrylic ester monomers such as methyl acrylate, ethyl acrylate, n-propyl acrylate, isopropyl acrylate, n-butyl acrylate, n-decyl acrylate, methyl methacrylate, ethyl methacrylate, n-propyl methacrylate, isopropyl methacrylate, n-butyl methacrylate, isobutyl methacrylate, n-amyl methacrylate, n-hexyl methacrylate, isoamyl methacrylate, allyl methacrylate, sec-butyl methacrylate, tert-butyl methacrylate, 2-ethylbutyl methacrylate, cinnamyl methacrylate, crotyl methacrylate, cyclohexyl methacrylate, cyclopentyl methacrylate, methallyl methacrylate, n-octyl methacrylate, 2-ethylhexyl methacrylate, 2-phenylethyl methacrylate and phenyl methacrylate.
0 to 60 mole percentage of other ethylenically unsaturated copolymerisable monomers such as styrene, alkyl-substituted styrenes and chloro-substituted styrenes, acrylonitrile, vinyl chloride, vinylidene fluoride and vinyl acetate.

The glycidyl group containing acrylic copolymers of the present composition preferably have an epoxy equivalent weight of 1.0 to 7.0 and preferably from 1.5 to 5.0 milliequivalents of epoxy/gram of polymer.

The glycidyl group containing acrylic copolymers may further be characterised by:
a number averaged molecular weight (Mn) ranging from 1.000 to 10000, measured by gel permeation chromatography (GPC);
a glass transition temperature (Tg) from 40 to 85° C., measured by Differential Scanning Calorimetry (DSC), according to ASTM D3418 with a heating gradient of 20° C. per minute;
an ICI (cone/plate) viscosity determined by the ICI method at 200° C. ranging from 50 to 50000 mPa.s.

The glycidyl group containing acrylic copolymer may fulfill one or more of the above conditions for its epoxy equivalent weight, its number averaged molecular weight, its glass transition temperature and its ICI viscosity. Preferably, the acrylic copolymer, however, fulfills all of the above requirements.

The curing agent (e) in accordance to the present invention, having functional groups reactive with the polyesters' carboxyl groups is a β-hydroxyalkylamide.

The β-hydroxyalkylamides, preferably used in the present invention, answer the general structure as represented in Formula 1.

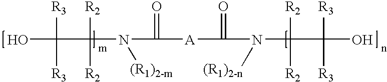

Wherein:
A represents a mono- or polyvalent organic group derived from a saturated or unsaturated alkyl group with 1 to 60 carbon atoms, or an aryl group, or a trialkene amino group with 1 to 4 carbon atoms per alkylene group, or a carboxy-alkenyl group, or an alkoxy carbonyl-alkenyl
R1 represents hydrogen, an alkyl group with 1 to 5 carbon atoms or a hydroxy alkyl group with 1 to 5 carbon atoms

R2 and R3 are the same or different and each indepently represents hydrogen or a straight or branched alkyl group with 1 to 5 carbon atoms, while one of the groups R2 and one of the groups R3 may also form, together with the adjacent carbon atoms, a cycloalkyl group. Preferably, the β-hydroxyalkylamide is according the following Formula II:

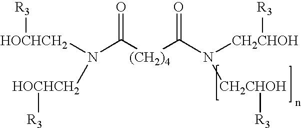

Where n is between 0.2 and about 1, and R3 is an hydrogen (Primid XL552 from EMS) or a methyl group (Primid QM1260 from EMS).

The carboxyl group containing amorphous polyester and the carboxyl group containing semi-crystalline polyesters of the present composition are preparable using conventional esterification techniques well known in the art. The polyesters are prepared according to a procedure consisting of one or more reaction steps.

For the preparation of these polyesters, a conventional reactor equipped with a stirrer, an inert gas (nitrogen) inlet, a thermocouple, a distillation column connected to a water-cooled condenser, a water separator and a vacuum connection tube can be used.

The esterification conditions used to prepare the polyesters are conventional, namely a standard esterification catalyst, such as dibutyltin oxide, dibutyltin dilaurate, n-butyltin trioctoate, sulphuric acid or a sulphonic acid, can be used in an amount from 0.05 to 1.50% by weight of the reactants and optionally, colour stabilisers, for example, phenolic antioxidants such as Irganox 1010 (Ciba) or phosphonite- and phosphite-type stabilisers such as tributylphosphite, can be added in an amount from 0 to 1% by weight of the reactants.

Polyesterification is generally carried out at a temperature which is gradually increased from 130° C. to about 190 to 250° C., first under normal pressure, then, when necessary, under reduced pressure at the end of each process step, while maintaining these operating conditions until a polyester is obtained, which has the desired hydroxyl and/or acid number. The degree of esterification is followed by determining the amount of water formed in the course of the reaction and the properties of the obtained polyester, for example the hydroxyl number, the acid number, the molecular weight or the viscosity.

When polyesterification is complete, cross-linking catalysts can optionally be added to the polyester while it is still in the molten state. These catalysts are added in order to accelerate cross-linking of the thermosetting powder composition during curing. Examples of such catalysts include amines (e.g. 2-phenylimidazoline), phosphines (e.g. triphenylphosphine), ammonium salts (e.g. tetrabutylammonium bromide or tetrapropylammonium chloride), phosphonium salts (e.g. ethyltriphenylphosphonium bromide or tetrapropylphosphonium chloride). These catalysts are preferably used in an amount of 0 to 5% with respect of the weight of the polyester.

The glycidyl group containing acrylic copolymer is preparable by conventional polymerisation techniques, either in mass, in emulsion, or in solution in an organic solvent. The nature of the solvent is very little of importance, provided that it is inert and that it readily dissolves the monomers and the synthesised copolymer. Suitable solvents include toluene, ethyl acetate, butyl acetate, xylene, etc. The monomers are copolymerised in the presence of a free radical polymerisation initiator (benzoyl peroxide, dibutyl peroxide, azo-bis-isobutyronitrile, and the like) in an amount representing 0.1 to 4.0% by weight of the monomers.

To achieve a good control of the molecular weight and its distribution, a chain transfer agent, preferably of the mercaptan type, such as n-dodecylmercaptan, t-dodecanethiol, iso-octylmercaptan, or of the carbon halide type, such as carbon tetrabromide, bromotrichloromethane, etc., is also added in the course of the reaction. The chain transfer agent is used in amounts of up to 10% by weight of the monomers used in the copolymerisation.

A cylindrical, double walled reactor equipped with a stirrer, a condenser, an inert gas (nitrogen, for example), inlet and outlet, and metering pump feed systems are generally used to prepare the glycidyl group containing acrylic copolymer.

Polymerisation can be carried out under conventional conditions. Thus, when polymerisation is carried out in solution, for example, an organic solvent is introduced into the reactor and heated to reflux temperature under an inert gas atmosphere (nitrogen, carbon dioxide, and the like) and a homogeneous mixture of the required monomers, free radical polymerisation initiator and chain transfer agent, when needed, is then added to the solvent gradually over several hours. The reaction mixture is then maintained at the indicated temperature for some hours, while stirring. The copolymer obtained is subsequently freed from the solvent in vacuo.

Preferably, the binder system of the thermosetting powdered composition of the present invention comprises, based on the total weight of the binder:
20 to 89.5, preferably 30 to 70 parts by weight of the carboxyl group containing amorphous isophthalic acid containing polyester (a),
5 to 50, preferably 5 to 30 parts by weight of the carboxyl group containing aliphatic semi-crystalline polyester, (b),
0 to 50, preferably 5 to 30 parts by weight of the carboxyl group containing semi-crystalline polyester (c);
5 to 40, preferably 5 to 25 parts by weight of the glycidyl group containing acrylic copolymer (d), and
0.5 to 10.0, preferably I to 5 parts by weight of the β-hydroxyalkylamide curing agent (e).

The binder system of the thermosetting composition of the present invention is preferably composed in such a way that for each equivalent of carboxyl group present in the amorphous polyester (a) and semi-crystalline polyesters (b) and (c) there is between 0.3 and 2.0 and preferably between 0.6 and 1.7 equivalents of epoxy groups from the acrylic copolymer (d) and between 0.2 and 1.2 and preferably between 0.4 and 1.0 equivalents of reactive functional groups of the β-hydroxyalkylamide curing agent (e).

The thermosetting polyester blend (a, b and c), when needed, can be obtained by dry blending the amorphous and the semi-crystalline polyesters using a mechanical mixing procedure as available for the premixing of the powder paint constituents.

Alternatively the amorphous and the semi-crystalline polyesters can be blended in the melt using a conventional cylindrical double-walled reactor or by extrusion such as with the Betol BTS40.

In addition to the essential components described above, compositions within the scope of the present invention can also include one or more additive(s) such as catalysts, fillers, flow control agents such as Resiflow PV5 (Worlee), Modaflow (Monsanto), Acronal 4F (BASF), etc., and degassing agents such as benzoin (BASF) etc. To the formulation UV-light absorbers such as Tinuvin 900 (Ciba), hindered amine light stabilisers represented by Tinuvin 144 (Ciba), other stabilising agents such as Tinuvin 312 and 1130 (Ciba), antioxidants such as Irganox 1010 (Ciba) and stabilisers from the phosphonite or phosphite type can be added.

Both, pigmented systems as well as clear lacquers can be prepared.

A variety of dyes and pigments can be utilised in the composition of this invention. Examples of useful pigments and dyes are metallic oxides such as titaniumdioxide, ironoxide, zincoxide and the like, metal hydroxides, metal powders, sulphides, sulphates, carbonates, silicates such as ammoniumsilicate, carbon black, talc, china clay, barytes, iron blues, lead blues, organic reds, organic maroons and the like.

The components of the composition according to the invention may be mixed by dry blending in a mixer or blender (e.g. drum mixer). The premix is then homogenised at temperatures ranging from 70 to 150° C. in a single screw extruder such as the BUSS-Ko-Kneter or a double screw extruder such as the PRISM or APV. The extrudate, when cooled down, is grounded to a powder with a particle size preferably ranging from 10 to 150 μm.

The powdered composition may be deposited on the substrate by use of a powder gun such as an electrostatic CORONA gun or TRIBO gun. On the other hand well known methods of powder deposition such as the fluidised bed technique can be used. After deposition the powder is heated to a temperature between 160 and 320° C., causing the particles to flow and fuse together to form a smooth, uniform, continuous, uncratered coating on the substrate surface.

Thus, the present invention further relates to the use of the above described compositions as powdered varnish or paint or for the preparation of a powdered varnish or paint. The invention further relates to the powdered varnishes or paints consisting of or comprising the present powdered thermosetting composition.

Furthermore, the present invention relates to a method of preparing a coating on a substrate comprising the steps of applying the above varnish or paint to the substrate and heating the coated substrate to fuse and cure the powdered varnish or paint to obtain the coating.

Furthermore, the present invention also refers to a coating preparable by the above method and a substrate entirely or partially coated with such coating.

The following examples are submitted for a better understanding of the invention but are not intended to restrict the invention thereto.

If not otherwise stated, all amounts are given in parts by weight.

Besides the abbreviations already defined above, OHN stands for hydroxyl number and Tm stands for fusion zone.

### EXAMPLE 1

### One Step Synthesis of a Carboxyl Functional Amorphous Polyester

423.4 parts of neopentyl glycol are placed in a conventional four neck round bottom flask equipped with a stirrer, a distillation column connected to a water cooled condenser, an inlet for nitrogen and a thermocouple attached to a thermoregulator.

The flask contents are heated, while stirring under nitrogen, to a temperature of circa 130° C. at which point 719.6 parts of isophthalic acid and 2.5 parts of n-butyltintrioctoate are added. The heating is continued gradually to a temperature of 230° C. Water is distilled from the reactor from 18020 C. on. When distillation under atmospheric pressure stops, a vacuum of 50 mm Hg is gradually applied. After three hours at 230° C. and 50 mm Hg, following characteristics are obtained:

| | |
|---|---|
| AN | 34 mg KOH/g |
| OHN | 3 mg KOH/g |
| ICI200° C. (cone/plate) | 2100 mPa · s |
| Tg (DSC, 20°/min) | 60° C. |

### EXAMPLE 2

### Two Step Synthesis of a Carboxyl Functional Amorphous Polyester

424.87 parts of neopentyl glycol are placed in a conventional four neck round bottom flask as in example 1.

The flask contents are heated, while stirring under nitrogen, to a temperature of circa 130° C. at which point 324.0 parts of terephthalic acid and 285.9 parts of isophthalic acid and 2.2 parts of n-butyltintrioctoate are added. The heating is continued gradually to a temperature of 230° C. Water is distilled from the reactor from 180° C. on. When distillation under atmospheric pressure stops, a vacuum of 50 mm Hg is gradually applied. After three hours at 230° C. and 50 mm Hg, following characteristics are obtained:

| | |
|---|---|
| AN | 9 mg KOH/g |
| OHN | 57 mg KOH/g |

To the first step prepolymer standing at 200° C., 111.3 parts of isophthalic acid are added. Thereupon, the mixture is gradually heated to 230° C. After a 2 hour period at 230° C. and when the reaction mixture is transparent, a vacuum of 50 mm Hg is gradually applied. After 3 hours at 230° C. and 50 mm Hg, following characteristics are obtained:

| | |
|---|---|
| AN | 31 mg KOH/g |
| OHN | 3 mg KOH/g |
| ICI200° C. (cone/plate) | 4400 mPa · s |
| Tg (DSC, 20°/min) | 54° C. |

### EXAMPLE 3 to 5

Accordingly the procedure as described in example 1, the amorphous polyesters of example 3 and example 4 are prepared.

Example 5 is prepared accordingly the procedure as for example 2. In a first step a terephthalic acid-neopentyl glycol prepolymer with hydroxyl number of 50 mg KOH/g is prepared. The hydroxyl functionalised prepolymer put into reaction with isophthalic acid giving a carboxyl functionalised amorphous polyester with acid number of 30 mg KOH/g.

TABLE 1

| | Example 3 | Example 4 | Example 5 |
|---|---|---|---|
| neopentyl glycol | 385.4 | 350.1 | 391.1 |
| 1,6-hexanediol | | 61.8 | |
| trimethylolpropane | 24.1 | 14.3 | |
| isophthalic acid | 733.6 | 716.1 | 85.2 |
| terephthalic acid | | | 664.7 |
| AN, mg KOH/g | 52 | 31 | 33 |
| OH, mg KOH/g | 4 | 3 | 4 |
| ICI200° C., mPa · s | 4700 | 2700 | 4500 |
| Tg (DSC 20° C./min), ° C. | 54 | 58 | 67 |

### EXAMPLE 6 to 9

### Synthesis of Carboxyl Functional Semi-Crystalline Polyesters

The 2 polyesters of examples 6 and 7 whose composition and properties are given in Table 2, are carboxyl functional aliphatic semi-crystalline polyesters (b), according to the invention. The 2 polyesters of examples 8 and 9 are carboxyl funtional semi-crystalline polyesters (c), whose presence is optional in the thermosetting powder compositions according to the invention.

TABLE 2

| | Example 6 | Example 7 | Example 8 | Example 9 |
|---|---|---|---|---|
| 1,4-cyclohexane- | 398.4 | 438.3 | 530.3 | |
| dimethanol | | | | |
| 1,6-hexanediol | | | | 454.9 |
| trimethylolpropane | | 15.9 | 15.9 | |
| adipic acid | | | 589.3 | |
| sebacic acid | | 668.7 | | |
| 1,12-dodecanedioic acid | 697.7 | | | |
| terephthalic acid | | | | 591.8 |
| isophthalic acid | | | | 92.0 |
| AN, mg KOH/g | 33 | 35 | 21 | 30 |
| OH, mg KOH/g | 2 | 2 | 1 | 1 |
| ICI200° C., mPa · s | 600 | 100 | 6400 | 3000 |
| Tm (DSC 20° C./min), | 52 | 44 | 100 | 130 |
| ° C. | | | | |

The carboxyl functional semi-crystalline polyesters of example 6 to 8 are prepared accordingly the procedure as for example 1.

The carboxyl functional semi-crystalline polyesters of example 9 is prepared accordingly the procedure as for example 2 where the isophthalic acid is put into reaction with an terephthalic acid-1,6-hexanediol based prepolymer with hydroxyl number of 40 mg KOH/g.

### EXAMPLE 10

### Preparation of the Glycidyl Group Containing Acrylic Copolymer

800 parts of n-butyl acetate are brought in a double walled flask of 5 1 equipped with a stirrer, a water cooled condenser, an inlet for nitrogen and a thermocouple attached to a thermoregulator. The flask content is then heated and stirred continuously while nitrogen is purged through the solvent. At a temperature of 125° C. a mixture of 38.5 parts of tert-butylperoxybenzoate in 200 parts of n-butyl acetate are fed in the flask during 215 minutes with a peristaltic pump. 5 minutes after this start another pump is started with the feeding of a mixture of 132 parts of styrene, 585 parts of glycidyl methacrylate, 123 parts of butyl methacrylate and 160 parts of methyl methacrylate, during 180 minutes. The synthesis takes 315 minutes.

After evaporation of the n-butyl acetate an acrylic copolymer with following characteristics is obtained:

| ICI viscosity @200° C. | 3500 mPa · s |
|---|---|
| Mn | 5800 |

### EXAMPLE 11 to 13

Accordingly the procedure as described in example 10, the acrylic copolymers of example 11 to example 13, answering the compositions as in table 3, were prepared.

TABLE 3

| | example 11 | example 12 | example 13 |
|---|---|---|---|
| glydidyl methacrylate | 563 | 565 | 284 |
| butyl methacrylate | 200 | | 312 |
| methyl methacrylate | 200 | 345 | 312 |
| t-butyl peroxybenzoate | 25 | 91 | 91 |
| Mn | 8400 | 1900 | 2600 |
| ICI200° C., mPa · s | 30000 | 24000 | 40000 |

### EXAMPLE 14

The polyesters and acrylic copolymers as illustrated above, are then formulated to a powder accordingly to one of the formulations as mentioned below.

| | |
|---|---|
| Formulation A | Formulation B |
| White paint formulation | Brown paint formulation |

| | | | |
|---|---|---|---|
| Binder | 74.00 | Binder | 78.33 |
| Kronos 2310 | 24.67 | Bayferrox 130 | 4.44 |
| Resiflow PV5 | 0.99 | Bayferrox 3950 | 13.80 |
| Benzoin | 0.34 | Carbon Black FW2 | 1.09 |
| | | Resiflow PV5 | 0.99 |
| | | Benzoin | 0.35 |

The composition of the binders is given in Table 4, where the binders I to 3 are according to the invention and binders 4 to 6 are comparative.

TABLE 4

| | Binder | Binder | Binder | Binder | Binder | Binder |
|---|---|---|---|---|---|---|
| | 1 | 2 | 3 | 4* | 5* | 6* |
| Amorphous | 595 | 527 | 553 | 570 | 592 | 645 |
| polyester | | | | | | |
| Semi- | 255 | 225 | 238 | 245 | 254 | 276 |
| crystalline | | | | | | |
| polyester(s) | | | | | | |
| Acrylic | 130 | 228 | 180 | 185 | 129 | |
| copolymer | | | | | | |
| Primid XL552 | 20 | 20 | 29 | | | |
| TGIC | | | | | 25 | 79 |

*The binders 4 to 6 are comparative

For the preparation of the powder formulation, the carboxyl functionalised isophthalic acid rich amorphous polyester resin and the carboxyl functionalised semi-crystalline polyester resins can be used as a blend or as separate resins. When used as a blend, blending is done by mixing the respectively resins in the molten state using a conventional round bottom flask.

The powders are prepared first by dry blending of the different components and then by homogenisation in the melt using a PRISM 16 mm L/D 15/1 twin screw extruder at an extrusion temperature of 85° C. The homogenised mix is then cooled and grinded in an Alpine UPZ100. Subsequently the powder is sieved to obtain a particle size between 10 and 110 μm. The powder thus obtained is deposited on cold rolled steel, by electrostatic deposition using the GEMA-Volstatic PCG 1 spray gun. At a film thickness between 50 and 80 μm the panels are transferred to an air-ventilated oven, where curing proceeds for 18 minutes at a temperature of 200° C. The paint characteristics for the finished coatings obtained from formulation A (example 15 to 33) and from formulation B (examples 34 to 37) with binder compositions as specified in table 4, are reproduced in table 5. In this table example 29 to example 33 are given by way of comparative examples.

TABLE 5

| | | Aliphatic | | | | | |
|---|---|---|---|---|---|---|---|
| | | semi- | Semi- | | | | |
| | Amorphous | crystalline | crystalline | Acrylic | | | |
| | Polyester | polyester | polyester | copolymer | Gloss | | |
| Binder | (a) | (b) | (c) | (d) | 60° | DI | RI |

Formulation A

| | | | | | | | | |
|---|---|---|---|---|---|---|---|---|
| Ex 15 | 1 | Ex 1 | Ex 6-33 | Ex 8-66 | Ex 10 | 71 | 200 | 200 |
| Ex 16 | 1 | Ex 1 | Ex 6-50 | Ex 8-50 | Ex 10 | 46 | 160 | 160 |
| Ex 17 | 1 | Ex 1 | Ex 6-66 | Ex 8-33 | Ex 10 | 28 | 140 | 120 |
| Ex 18 | 1 | Ex 1 | Ex 6-100 | | Ex 10 | 20 | 100 | 80 |
| Ex 19 | 3 | Ex 3 | Ex 6-66 | Ex 8-33 | Ex 11 | 30 | 120 | 100 |
| Ex 20 | 1 | Ex 1 | Ex 7-66 | Ex 8-33 | Ex 10 | 65 | 140 | 160 |
| Ex 21 | 3 | Ex 3 | Ex 7-66 | Ex 9-33 | Ex 11 | 45 | 200 | 200 |
| Ex 22 | 3 | Ex 3 | Ex 7-33 | Ex 9-66 | Ex 11 | 58 | 100 | 120 |
| Ex 23 | 1 | Ex 2 | Ex 6-66 | Ex 8-33 | Ex 10 | 29 | 120 | 120 |
| Ex 24 | 1 | Ex 2 | Ex 6-100 | | Ex 10 | 22 | 100 | 100 |
| Ex 25 | 1 | Ex 4 | Ex 6-50 | Ex 8-50 | Ex 12 | 45 | 180 | 160 |
| Ex 26 | 1 | Ex 4 | Ex 6-33 | Ex 8-66 | Ex 12 | 65 | 200 | 180 |
| Ex 27 | 2 | Ex 4 | Ex 6-33 | Ex 8-66 | Ex 13 | 55 | 120 | 100 |
| Ex 28 | 1 | Ex 5 | Ex 6-66 | Ex 8-33 | Ex 10 | 44 | 100 | 20 |
| Ex 29* | 3 | Ex 3 | | Ex 8-33 | Ex 11 | 88 | 120 | 80 |
| | | | | Ex 9-66 | | | | |
| Ex 30* | 1 | Ex 1 | | Ex 8-100 | Ex 10 | 89 | 200 | 200 |
| Ex 31* | 4 | Ex 1 | Ex 6-66 | Ex 8-33 | Ex 10 | 29 | 40 | 20 |
| Ex 32* | 5 | Ex 1 | Ex 6-66 | Ex 8-33 | Ex 10 | 25 | 40 | 20 |
| Ex 33* | 6 | Ex 1 | Ex 6-66 | Ex 8-33 | | 68 | 0 | 0 |

Formulation B

| | | | | | | | | |
|---|---|---|---|---|---|---|---|---|
| Ex 34 | 1 | Ex 1 | Ex 6-33 | Ex 8-66 | Ex 10 | 74 | 180 | 200 |
| Ex 35 | 1 | Ex 1 | Ex 6-66 | Ex 8-33 | Ex 10 | 30 | 140 | 140 |
| Ex 36 | 1 | Ex 2 | Ex 6-66 | Ex 8-33 | Ex 10 | 29 | 120 | 100 |
| Ex 37 | 1 | Ex 5 | Ex 6-66 | Ex 8-33 | Ex 10 | 40 | 80 | 20 |

### EXAMPLES 29 TO 33 ARE COMPARATIVE

In this table:
Column 1: indicates the identification number of the formulation
Column 2: indicates the binder composition
Column 3: indicates the type of amorphous polyester (a)
Column 4: indicates the type and weight% of aliphatic semi-crystalline polyester (b) on the sum polyesters (b) +(c)
Column 5: indicates the type and weight% of semi-crystalline polyester optionally used according to the invention, on the sum of polyesters (b) +(c)
Column 6: indicates the type of acrylic copolymer (d)
Column 7: indicates the 60° gloss, measured according to ASTM D523
Column 8: indicates the direct impact strength according to ASTM D2794. The highest impact which does not crack the coating is recorded in kg.cm
Column 9: indicates the reverse impact strength according to ASTM D2794. The highest impact which does not crack the coating is recorded in kg.cm

For a1 the coatings as obtained from the different formulations (accordingly the invention as well as from those of the comparative examples), a very smooth visual perception, free of any defects, is perceived.

Besides, the different coatings of the formulations according to the invention (examples 15 to 28), all have a flexibility of 0T or 1T maximum, according to the ASTM D4145-83 T-bending test. For the comparative examples (examples 29 to 33), T-bending values equal to or higher than 2T are observed.

As clearly appears from table 5, the aliphatic semi-crystalline polyester containing linear aliphatic C10-C16 dicarboxylic acids is necessary for having coatings proving reduced gloss (example 16 versus example 30 and example 19 versus example 29). Changing the type of linear aliphatic dicarboxylic acid results in a modified gloss level (example 17 versus example 20).

It also appears that increasing the amount of the aliphatic semi-crystalline polyester containing linear aliphatic C10-C16 dicarboxylic acids, in the binder composition, induces a proportional gloss reduction of the coating derived (example 15 to example 18, example 21 versus example 22, example 23 versus example 24, example 25 versus example 26).

Also, it appears that increasing the amount of terephthalic acid in the amorphous carboxyl functional polyester, within the preferred range of the present invention, does not influence the coating properties as long as gloss and flexibility are concerned.

Increasing the terephthalic acid content to a proportion where it becomes preponderant to the isophthalic acid content, influences gloss and flexibility (example 17 versus example 23 versus example 28).

Increasing the acrylic equivalent weight influences gloss and flexibility of the derived paint film (example 26 versus example 27).

The presence of the β-hydroxyalkylamide hardener is necessary for getting a paint film proving flexibility (example 17 versus example 31).

Replacing the β-hydroxyalkylamide hardener by a glycidyl group containing hardener, well known in the art, such as triglycidylisocyanurate (TGIC), has no influence on the gloss level, yet tremendously reduces paint flexibility (example 17 versus example 32).

Replacing the hardener system of the present invention (glycidyl containing acrylic copolymer and β-hydroxyalkylamide) by a hardener generally used in commercial powder coatings intended for outdoor applications, such as triglycidylisocyanurate, results in coatings proving a complete lack of flexibility (example 17 versus example 33).

From all these examples it clearly appears that for getting a flexible low gloss or semi-matt powder coating from a formulation obtained in a single extrusion process, the powder formulation necessarily must comprise:
a carboxyl functional isophthalic acid containing amorphous polyester, from which the acid constituent is composed of at least 10 mole % of isophthalic acid and preferably of 50 mole % of isophthalic acid;
an aliphatic carboxyl functional semi-crystalline polyester, derived from linear chain C10-C16 aliphatic dicarboxylic acids, preferably in combination with another carboxyl functional semi-crystalline polyester;
a glycidyl group containing acrylic copolymer for reacting with the polyester carboxylic acid groups;
a β-hydroxyalkylamide group containing cross-linking agent.

Besides, the coatings according to the present invention all prove to satisfy an excellent outdoor resistance, comparable to or better than the currently used nowadays commercial available powders.

In table 6, the relative 60° gloss values, recorded every 400 hours, according to ASTM D523, are reported for the coating obtained from examples 34 and 35, submitted to the Q-UV accelerated weathering test. In the same table (comparison) are given the weathering results of a carboxylic acid functionalised amorphous polyester obtained by reacting 400,6 parts of neopentyl glycol, 22,3 parts of trimethylolpropane and 724,7 parts of isophthalic acid, in the same manner as in example 3.

This polyester has an AN of 32 mg KOH/g and a Tg of 59° C., determined by DSC with a heating rate of 20° C./min. This polyester is formulated in a 93/7 ratio with PT810 according to the brown paint formulation as in formulation B.

In this table only gloss reductions until 50% of the maximum value are mentioned. Weathering measurements are conducted in a very severe environment, i.e. the Q-UV accelerated weathering tester (Q-Panel Co) according to ASTM G53-88 (standard practice for operating light and water exposure apparatus—fluorescent UV/condensation type—for exposure of non metallic materials).

For this table, coated panels have been subjected to the intermittent effects of condensation (4 hours at 50° C.) as the damaging effects of sunlight simulated by fluorescent UV-A lamps (340 nm, I=0.77 W/m²/nm) (8 hours at 60° C.).

TABLE 6

| | UV-A (340 nm, I = 0.77 W/m²/nm | | |
|---|---|---|---|
| | Formulation B | Formulation B | |
| Hours | example 34 | example 35 | Comparison |
| 0 | 100 | 100 | 100 |
| 400 | 100 | 99 | 100 |
| 800 | 99 | 100 | 100 |
| 1200 | 98 | 97 | 97 |
| 1600 | 98 | 96 | 97 |
| 2000 | 97 | 97 | 97 |
| 2400 | 98 | 96 | 96 |
| 2800 | 99 | 94 | 95 |
| 3200 | 98 | 88 | 92 |
| 3600 | 95 | 85 | 89 |
| 4000 | 90 | 86 | 87 |
| 4400 | 87 | 84 | 84 |
| 4800 | 84 | 80 | 79 |
| 5200 | 78 | 75 | 76 |
| 5600 | 77 | 71 | 73 |
| 6000 | 74 | 67 | 67 |
| 6400 | 53 | 59 | 59 |
| 6800 | 54 | 50 | 54 |
| 7200 | 47 | 41 | 49 |
| 7600 | 40 | | |

1. Powdered thermosetting composition useful for preparing semi-matt coatings, including a binder which comprises
(a) a carboxyl group containing amorphous isophthalic acid containing polyester,
(b) a carboxyl group containing aliphatic semi-crystalline polyester,
(c) optionally, a carboxyl group containing semi-crystalline polyester other than (b)
(d) at least 5 parts by weight, based on the total weight of the binder, of a glycidyl group containing acrylic copolymer, said copolymer comprising at least 10 mole % of a glycidyl group containing monomer and having a numbered averaged molecular weight (Mn) of 10000 or less, and
(e) a β-hydroxyalkylamide group containing curing agent whose functional groups are reactive with the polyesters' carboxyl groups.

2. Composition according to claim 1, wherein the carboxyl group containing amorphous isophthalic acid containing polyester (a) consists of 10-100 mole % isophthalic acid and 0-90 mole % of another diacid, based on the total of the acid constituents, and 35-100 mole % neopentyl glycol and/or 2-butyl-2-ethyl-1,3-propanediol and 0-65 mole % of another diol, based on the total of the alcohol constituents.

3. Composition according to claim 2, wherein the carboxyl group containing amorphous isophthalic acid containing polyester further contains up to 15 mole % of polyacids relative to the diacids and/or up to 15 mole % of polyols, relative to the neopentylglyol and/or 2-butyl-2-ethyl-1,3-propanediol.

4. Composition according to claim 1, wherein the carboxyl group containing amorphous isophthalic acid containing polyester (a) has an acid number (AN) from 15-70 mg KOH/g, a number averaged molecular weight (Mn) from 1600 to 11000, a glass transition temperature (Tg) from 40-80° C. and an ICI (cone/plate) viscosity at 200° C. from 5-15000 mPa.s.

5. Composition according to claim 1, wherein the carboxyl group containing semi-crystalline aliphatic polyester (b) constists of 40-100 mole % of linear chain dicarboxlic acid containing 10 to 16 carbon atoms and 0-60 mole % of at least one linear chain dicarboxylic acid containing 4 to 9 carbon atoms, based on the total of the acid constituents, and at least one aliphatic non-branched or cycloaliphatic diol containing 2 to 16 carbon atoms, as the alcohol constituent.

6. Composition according to claim 1, wherein the optional carboxyl group containing semi-crystalline polyester (c) consists of 75-100 mole % of 1,4-cyclohexanedicarboxylic acid and/or terephthalic acid and/or a linear chain dicarboxylic acid containing 4 to 9 carbon atoms, and of 0-25 mole % of another aliphatic, cycloaliphatic or aromatic diacid, based on the total of the acid constituents, and 75-100 mole % of a cycloaliphatic or linear chain diol containing 2 to 16 carbon atoms and 0-25 mole % of another aliphatic diol, based on the total of the alcohol constituents.

7. Composition according to 5 or 6, wherein the carboxyl group containing semi-crystalline polyesters (b) and (c) further contains up to 15 mole % of polyacids relative to the 1,4-cyclohexanedicarboxylic acid and/or terephthalic acid and/or linear chain dicarboxylic acid, and/or up to 15 mole % of polyols, relative to the diols.

8. Composition according to claim 1, wherein the carboxyl group containing semi-crystalline polyesters (b) and (c) both have an acid number (AN) from 10-50 mg KOH/g, a number averaged molecular weight (Mn) from 2200-17000, a fusion zone from 30-150° C., a glass transition temperature (Tg) from −50 to 50° C, a degree of crystallinity of at least 5 J/g and an ICI (cone/plate) viscosity at 175° C. from 5-20000 mPa.s.

9. Composition according to claim 1, wherein the glycidyl group containing acrylic copolymer consists of 10-90 mole % of a glycidyl group containing monomer selected from the group consisting of glycidyl acrylate, glycidyl methacrylate, methyl glycidyl acrylate, methyl glycidyl methacrylate, 3,4-epoxycyclohexylmethyl acrylate, 3,4-epoxycyclohexylmethyl methacrylate, acrylic glycidyl ether and mixtures thereof and 10-90 mole % of monomers copolymerisable with the glycidyl group containing monomers.

10. Composition according to claim 1, wherein the glycidyl group containing acrylic copolymer has an epoxy equivalent weight of 1.0 to 7.0 milliequivalent of epoxy/gram of polymer, a number averaged molecular weight (Mn) ranging from 1000 to 10000, a glass transition temperature (Tg) from 40-85° C. and an ICI (cone/plate) viscosity at 200° C. from 60-50000 mPa.s.

11. Composition according to claim 1, wherein the binder comprises, based on the total weight of the binder,
(a) 20 to 89.5 parts by weight of the carboxyl group containing amorphous isophthalic acid containing polyester,
(b) 5 to 50 parts by weight of the carboxyl group containing aliphatic semi-crystalline polyester,
(c) 0 to 50 parts by weight of the carboxyl group containing semi-crystalline polyester other than (b);
(d) 5 to 40 parts by weight of the glycidyl group containing acrylic copolymer, and
(e) 0.5 to 10.0 parts by weight of the β-hydroxyalkylamide group containing curing agent.

12. Composition according to claim 1, further comprising one or more additive(s) selected from the group consisting of catalysts, fillers, flow control agents, degassing agents, UV-light absorbers, light stabilizers, antioxidants and other stabilizers.

13. Composition according to claim 1, further comprising one or more dyes and/or pigments.

14. Method of preparing a composition as claimed in claim 1 comprising the steps of blending the components of the composition to prepare a premix, homogenising the premix at an elevated temperature such as 70-150° C. and grounding the homogenised product to obtain the powdered thermosetting composition.

15. Method according to claim 14, wherein in a first step the amorphous polyester and the semi-crystalline polyesters are dry blended or melt blended.

16. Powdered varnish or paint consisting of or comprising a composition as claimed in claim 1.

17. Method of preparing a coating on a substrate comprising the steps of applying a powdered varnish or paint as claimed in claim 16 to the substrate and heating the coated substrate to fuse and cure the powdered varnish or paint to obtain the coating.

18. Coating, preparable by the method of claim 17.

19. Substrate entirely or partially coated with the coating of claim 18.

20. The composition according to claim 13 wherein said one or more dyes and/or pigments are metal oxides, metal hydroxides, metal powders, sulphides, sulphates, carbonates, silicates, carbon black, talc, china clay, barytes, iron blue, lead blue, organic reds and organic maroons.

21. The method according to claim 14 wherein said elevated temperature is 70-150° C.
